(19) United States
(12) Patent Application Publication
(10) Pub. No.: US 2025/0056288 A1
(43) Pub. Date: Feb. 13, 2025

(54) OBTAINING MEASURED INFORMATION AND PREDICTED INFORMATION RELATED TO AI/ ML MODEL

(71) Applicant: Nokia Technologies Oy, Espoo (FI)

(72) Inventors: Fahad SYED MUHAMMAD, Massy (FR); Bharath Ramesh Kashyap, Bangalore (IN); Wolfgang Zirwas, Munich (DE); Dimitri Gold, Espoo (FI)

(21) Appl. No.: 18/784,301

(22) Filed: Jul. 25, 2024

(30) Foreign Application Priority Data
Aug. 9, 2023 (IN) 202341053447

(51) Int. Cl. H04W 24/10; H04B 7/06; H04L 5/00; H04W 24/02

(52) U.S. Cl. CPC H04W 24/10; H04B 7/0626; H04L 5/0053; H04W 24/02

(57) ABSTRACT

Example embodiments of the present disclosure relate to obtaining of measured information and predicted information related to an Artificial Intelligence (AI)/Machine Learning (ML) model. In an example method, a first apparatus performs, during a first time period, first one or more measurements to obtain first measured information related to the first time period. The first apparatus determines, based on the first measured information, predicted information related to a second time period which is after the first time period. The first apparatus performs, during the second time period, second one or more measurements to obtain second measured information related to the second time period. The first apparatus transmits, to a second apparatus, the second measured information and the predicted information. In this way, a test mechanism framework may evaluate the prediction accuracy for AI/ML based prediction use case.

### FIELD

Example embodiments of the present disclosure generally relate to the field of communications, and in particular, to devices, methods, apparatuses and a computer readable storage medium for obtaining measured information and predicted information related to Artificial Intelligence (AI)/Machine Learning (ML) model.

### BACKGROUND

In the communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for wireless data traffic having increased since deployment of 4th generation (4G) communication systems, efforts have been made to develop an improved 5th generation (5G), pre-5G, 6G communication systems or beyond.

A study of AI ML for New Radio (NR) air interface is now ongoing in 3GPP. One of the objectives of the study is to cover the interoperability and testability aspect of the newly defined AI/ML enabled features. Besides, an AI/ML enabled CSI feedback enhancement is one of the selected use-case for the study item. One of the selected sub use cases for CSI feedback enhancement is CSI prediction. However, there are still some open problems in the AI/ML based measurements that will be studied.

### SUMMARY

In general, example embodiments of the present disclosure provide a solution for obtaining measured information and predicted information related to Artificial Intelligence (AI)/Machine Learning (ML) model, especially, further for providing a test mechanism for AI/ML based CSI prediction accuracy.

In a first aspect, there is provided a first apparatus. The first apparatus comprises at least one processor and at least one memory storing instructions that, when executed by the at least one processor, cause the first apparatus at least to: perform, during a first time period, first one or more measurements to obtain first measured information related to the first time period; determine, based on the first measured information, predicted information related to a second time period which is after the first time period; perform, during the second time period, second one or more measurements to obtain second measured information related to the second time period; and transmit, to a second apparatus, the second measured information and the predicted information

In a second aspect, there is provided a second apparatus. The second apparatus comprises at least one processor and at least one memory storing instructions that, when executed by the at least one processor, cause the second apparatus at least to: transmit, to a first apparatus, configuration information for configuring the first apparatus to obtain measured information and predicted information related to a time period, wherein the predicted information is to be obtained based on an artificial intelligence (AI)/machine learning (ML) model; receive, from the first apparatus, the measured information and the predicted information related to the time period; and determine performance information of the AI/ML model based on the measured information and the predicted information

In a third aspect, there is provided a method. The method comprises performing, at a first apparatus during a first time period, first one or more measurements to obtain first measured information related to the first time period; determining, based on the first measured information, predicted information related to a second time period which is after the first time period; performing, during the second time period, second one or more measurements to obtain second measured information related to the second time period; and transmitting, to a second apparatus, the second measured information and the predicted information.

In a fourth aspect, there is provided a method. The method comprises transmitting, at a second apparatus and to a first apparatus, configuration information for configuring the first apparatus to obtain measured information and predicted information related to a time period, wherein the predicted information is to be obtained based on an artificial intelligence (AI)/machine learning (ML) model; receiving, from the first apparatus, the measured information and the predicted information related to the time period; and determining performance information of the AI/ML model based on the measured information and the predicted information.

In a fifth aspect, there is provided a first apparatus. The first apparatus comprises means for performing, during a first time period, first one or more measurements to obtain first measured information related to the first time period; means for determining, based on the first measured information, predicted information related to a second time period which is after the first time period; means for performing, during the second time period, second one or more measurements to obtain second measured information related to the second time period; and means for transmitting, to a second apparatus, the second measured information and the predicted information.

In a sixth aspect, there is provided a second apparatus. The second apparatus comprises means for transmitting, to a first apparatus, configuration information for configuring the first apparatus to obtain measured information and predicted information related to a time period, wherein the predicted information is to be obtained based on an artificial intelligence (AI)/machine learning (ML) model; means for receiving, from the first apparatus, the measured information and the predicted information related to the time period; and means for determining performance information of the AI/ML model based on the measured information and the predicted information.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to perform at least the method according to any one of the above third to fourth aspect.

In a ninth aspect, there is provided a first apparatus. The first apparatus comprises performing circuitry configured to perform, during a first time period, first one or more measurements to obtain first measured information related to the first time period; determining circuitry configured to determine, based on the first measured information, predicted information related to a second time period which is after the first time period; performing circuitry configured to perform, during the second time period, second one or more measurements to obtain second measured information related to the second time period; and transmitting circuitry configured to, to a second apparatus, the second measured information and the predicted information.

In a tenth aspect, there is provided a second apparatus The second apparatus comprises transmitting circuitry configured to transmit, to a first apparatus, configuration information for configuring the first apparatus to obtain measured information and predicted information related to a time period, wherein the predicted information is to be obtained based on an artificial intelligence (AI)/machine learning (ML) model; receiving circuitry configured to receive, from the first apparatus, the measured information and the predicted information related to the time period; and determining circuitry configured to determine performance information of the AI/ML model based on the measured information and the predicted information.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a network environment in which example embodiments of the present disclosure can be implemented;

FIG. 2 illustrates a process flow of method according to some embodiments of the present disclosure;

FIG. 3 illustrates an example of test framework in accordance with some example embodiments of the present disclosure;

FIG. 4 illustrates an example of an interaction between a Test Equipment (TE) and Device Under Test (DUT) in accordance with some example embodiments of the present disclosure;

FIG. 5 illustrates an example of a flow of messages between the DUT and the TE in accordance with some example embodiments of the present disclosure;

FIG. 6 illustrates a flowchart of a method performed by an apparatus in accordance with some example embodiments of the present disclosure;

FIG. 7 illustrates a flowchart of a method performed by an apparatus in accordance with some example embodiments of the present disclosure;

FIG. 8 illustrates a simplified block diagram of a device that is suitable for implementing some example embodiments of the present disclosure; and

FIG. 9 illustrates a block diagram of an example of a computer readable medium 800 in accordance with some example embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuits (such as i analog and/or digital circuits) and
(b) combinations of hardware circuits and software, such as (as applicable):
   (i) a combination of analog and/or digital hardware circuit(s) with software (e.g., firmware); and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “cellular network” refers to a network operating in accordance with any suitable radio access technology defined by standards, such as Long Term Evolution (LTE), LTE-Advanced (LTE-A), new radio Wideband Code Division Multiple Access (WCDMA), High-Speed Packet Access (HSPA), Narrow Band Internet of Things (NB-IoT) and so on. Furthermore, the communications between a terminal device and a network device of a cellular network may be performed according to any suitable communication protocols, including, but not limited to, the fourth generation (4G), 4.5G, the future fifth generation (5G) communication protocols, and/or any other protocols either currently known or to be developed in the future. Embodiments of the present disclosure may be applied in various cellular networks. Given the rapid development in communications, there will of course also be future type communication technologies and systems with which the present disclosure may be embodied. It should not be seen as limiting the scope of the present disclosure to only the aforementioned system.

As used herein, the term “network device” refers to any device in a cellular network via which a terminal device accesses a data network and receives services exposed by other network devices of the cellular network. In some examples, a network device may comprise or implement a network function of a 5^{th} generation communication system (5GS) (e.g., a core network) of a cellular network. In some examples, the network devices may be located at the RAN of the 5GS. The network device may be part of a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico node, and so forth, depending on the applied terminology and technology. A gNB may include a centralized unit CU and one or more distributed DUs. Femto and Pico nodes are small base stations with a small coverage area.

The term “terminal device” refers to a device of a communication system of a cellular network, such as a 5^{th} generation communication system (5GS) that may be capable of wireless (e.g., radio) communication with a NR-RAN of the 5GS). By way of example rather than limitation, a terminal device may also be referred to as a wireless communication device, user equipment (UE), a Subscriber Station (SS), a Portable Subscriber Station, a Mobile Station (MS), or an Access Terminal (AT). Examples of a terminal device include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

RAN4 only starts the work of the interoperability and testability aspect of the AI/ML enabled features after there is sufficient progress on use case study in RAN1 and RAN2. For example, the requirements and testing frameworks may validate AI/ML based performance enhancements and ensuring that UE and gNB with AI/ML meet or exceed the existing minimum requirements if applicable. The need and implications for AI/ML processing capabilities definition are also considered. The aspects of inference performance evaluation for different selected use cases for AI/ML enabled features are also discussed by RAN 4. For example, for metrics for CSI requirements/tests for model inference performance testing, possible test metrics are considered, such as throughput (absolute throughput or relative throughput). If throughput is not applicable or significant disadvantage is observed by using throughput, intermediate KPIs/other test metric, such as cosine similarity, accuracy of predicted CQI, etc., may be considered. However, the issue that whether the KPIs are testable is questionable. CSI prediction accuracy is one of the selected test metrics/KPIs for performance evaluation of inference in RAN4.

For CSI prediction use case, CSI prediction accuracy is one of the test metrics currently under consideration in RAN4 for inference performance verification. Therefore, it is important to find a test mechanism to verify CSI prediction accuracy. One of the main challenges in such verification is the extraction of the ground truth. If the ground truth is known at the Device Under Test (DUT) side, then a mechanism is needed as well to transport it to the test equipment (TE) or the test validation entity.

In view of the above, example embodiments of the present disclosure provide a solution for obtaining measured information and predicted information related to Artificial Intelligence (AI)/Machine Learning (ML) model, and particularly provide a framework to extract the ground truth for predicted CSI values and to report this ground truth to the TE to compare it with the predicted CSI values. Especially, in the example embodiments of the present disclosure, a first apparatus may perform, during a first time period, first one or more measurements to obtain first measured information related to the first time period. The first apparatus may further determine, based on the first measured information, predicted information related to a second time period which is after the first time period. The first apparatus may perform, during the second time period, second one or more measurements to obtain second measured information related to the second time period and transmit, to a second apparatus, the second measured information and the predicted information. In this way, the measured information and predicted information related to the AI/ML model are obtained, e.g., for evaluating the AI/ML model, and the test mechanism framework may evaluate the CSI prediction accuracy for AI/ML based CSI prediction use case.

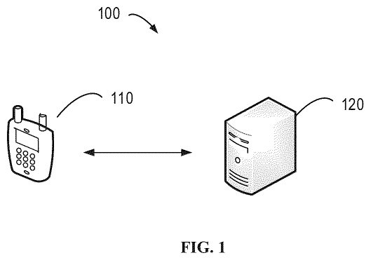

FIG. 1 illustrates an example of a network environment 100 in which example embodiments of the present disclosure can be implemented. The environment 100 may be a part of a communication network and comprise a plurality of terminal devices, such as a first apparatus 110, a second apparatus 120. As an example, the first apparatus 110 may be implemented as Device Under Test (DUT) or User Equipment (UE), and the second apparatus 120 may be implemented as a test equipment (TE) or a test validation entity. The first apparatus 110 may communicate and transmit various data to the second apparatus 120 via network environment 100.

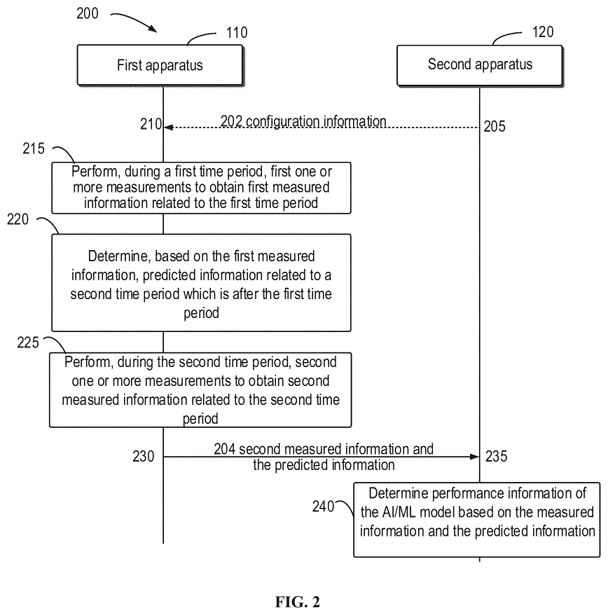

FIG. 2 illustrates a process flow of method according to some embodiments of the present disclosure. For the purpose of discussion, the process flow 200 will be described with reference to FIG. 1. It would be appreciated that although the process flow 200 has been described referring to FIG. 1, this process flow 200 may be likewise applied to other similar communication scenarios.

In the process flow 200, the second apparatus 120 may transmit (205) configuration information 202 to a first apparatus 110 for configuring the first apparatus 110 to obtain measured information and predicted information related to a time period. The predicted information may be obtained based on an artificial intelligence (AI)/machine learning (ML) model. In some embodiments, it is noted that the predicted information may be a physical layer based channel prediction using filters.

Upon receiving (210) the configuration information 202 for configuring the first apparatus 110 to obtain the measured information and the predicted information related to a time period from the second apparatus 120, the first apparatus 110 may perform (215) first one or more measurements to obtain first measured information related to the first time period, during a first time period.

In some embodiments, the first apparatus 110 may transmit an acknowledgement information to the second apparatus. The acknowledgement information indicates that the first apparatus 110 has been configured to obtain the second measured information and the predicted information related to the second time period.

Further, the first apparatus 110 may receive a request from the second apparatus 120 that the first apparatus 110 transmits the second measured information and the predicted information to the second apparatus. The transmitting of the second measured information and the predicted information is responsive to the request. Alternatively, or additionally, the first apparatus 110 may determine the predicted information by inputting the first measured information into the artificial intelligence (AI)/machine learning (ML) model during the second time period.

As an example, the first apparatus may perform the second one or more measurements by measuring first one or more channel state information (CSI)-reference signals (RS) from the second apparatus, wherein the first one or more CSI-RSs are transmitted during the second time period and at least one of (i) without noise and interference or (ii) with a power boost. In some embodiments, the first one or more CSI-RSs are transmitted without noise and interference and are transmitted in parallel to second one or more CSI-RSs with noise and interference; and resources for receiving the first one or more CSI-RSs are orthogonal to resources for receiving the second one or more CSI-RSs.

In some further embodiments, the predicted information may comprise predicted CSI report, and the predicted CSI report is transmitted to the second apparatus within a first reporting time period aligned with a plurality of predicted CSI reports; or a second reporting time period longer than the first reporting time period.

The first apparatus 110 may further determine (220) predicted information related to a second time period which is after the first time period based on the first measured information. Alternatively, or additionally, the first apparatus 110 may determine predicted information related to the second time period based on the first measured information and AI/ML model both.

The first apparatus 110 may perform (225) second one or more measurements to obtain second measured information related to the second time period during the second time period. The first apparatus 110 may then transmit (230) the second measured information and the predicted information 204 to the second apparatus 120. In some embodiments, the first measured information and the second measured information may comprise measured CSI, and the predicted information may comprise predicted CSI.

Upon receiving (235) the second measured information and the predicted information 204 from the first apparatus 110, the second apparatus 120 may determine (240) performance information of the AI/ML model based on the measured information and the predicted information.

In some cases, the second apparatus 120 may receive acknowledgement information from the first apparatus 110. The acknowledgement information indicates that the first apparatus 110 has been configured to obtain the measured information and the predicted information related to the time period. In some embodiments, the second apparatus 120 may transmit a request to the first apparatus 110 that the first apparatus transmits the measured information and the predicted information to the second apparatus prior to receiving the measured information and the predicted information.

Without any limitation, the second apparatus 120 may determine the performance information by comparing the predicted information to the measured information, and deriving a key performance indicator (KPI) of the AI/ML model based on the comparison.

Moreover, the second apparatus 120 may determine a test on the AI/ML model is passed based on determining that the KPI is within a tolerance range. Otherwise, the second apparatus 120 may determine the test on the AI/ML model is failed based on determining that the KPI is outside the tolerance range. In some embodiments, the second apparatus 120 may determine at least one requirement for testing the AI/ML model, and the second apparatus 120 may then determine the configuration information based on the at least one requirement.

In some example scenarios, the second apparatus 120 may transmit first one or more channel state information (CSI)-reference signals (RS) to the first apparatus 110. The first one or more CSI-RSs may be transmitted without noise and interference or with a power boost. In some embodiments, the first one or more CSI-RSs may be transmitted without noise and interference and are transmitted in parallel to second one or more CSI-RSs with noise and interference. The resources for transmitting the first one or more CSI-RSs are orthogonal to resources for transmitting the second one or more CSI-RSs.

In general, the predicted information can be any information (for example, any information which is useful for the communications of the first apparatus) that is predicted by the AI/ML model. For instance, the predicted information may comprise a predicted CSI report, and the predicted CSI report is received from the first apparatus within a first reporting time period aligned with a plurality of predicted CSI reports, or a second reporting time period longer than the first reporting time period. The measured information may comprises measured CSI, the predicted information may comprise predicted CSI, and the performance information may comprise CSI prediction accuracy. The first apparatus 110 may be a device under test (DUT), and the second apparatus 120may be test equipment (TE).

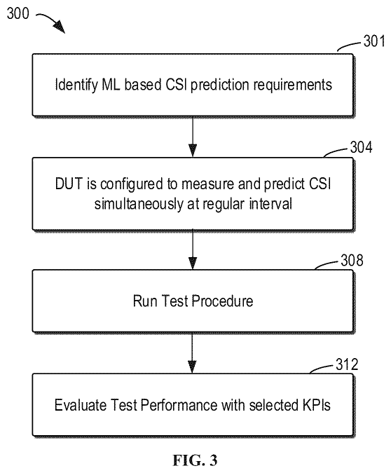

FIG. 3 illustrates an example of test framework 300 in accordance with some example embodiments of the present disclosure. As illustrated in FIG. 3, at block 301, ML based CSI prediction requirements may be identified. The goal of this step is to identify the requirements of the considered ML based CSI prediction model in a clear manner. In some embodiments, it is assumed that the ML model is already trained. A set of requirements and assumptions should be associated with the trained ML model. This refers to the ML inputs (type such as historical CSI values, RSRP values etc.), targeted CSI prediction accuracy and optionally any delay/time duration to complete the test procedure.

At block 304, a DUT is configured to measure and predict CSI simultaneously at a regular interval. Through this step, the established requirements and assumptions may be mapped to the test. The DUT is configured to measure the CSI at some regular interval, this interval can be significantly higher than the actual CSI reporting frequency to reduce the overhead and computational complexity at the DUT side. These measurement intervals are overlapped with the CSI prediction horizon to capture the ground truth for the corresponding predicted value of CSI.

The DUT may estimate the ground truth before it can be reported because the test procedure should include different signal to interference and noise ratios (SINR). A low SINR may cause the estimated ground truth to be quite inaccurate. transmitting from the TE noise and interference free CSI RSs at the predicted time instances may be an enhancement and allow the UEs an accurate channel estimation at the prediction time.

Additionally, an alternative implementation may be to transmit in parallel noisy CSI RSs as well as on orthogonal resources noise free CSI RSs, where the noise free CSI RSs may be used to infer the ground truth channel estimates. The orthogonal CSI RSs for the ground truth estimation may be then allocated to resource elements. In some embodiments, the TE transmits the CSI RS with a certain power boost Peoost at the prediction time, so that the SINR is increased by the related power boost value Peoost.

At block 308, A test procedure may be run. The DUT may store the corresponding measured and predicted CSI and reports both values to TE. The TE may compare the predicted values with the reported ground truth. At block 312, a test performance may be evaluated with selected KPIs. For example, the test result may be analyzed, and the performance may be derived following selected KPIs (e.g., 90% percentile of achieved accuracy).

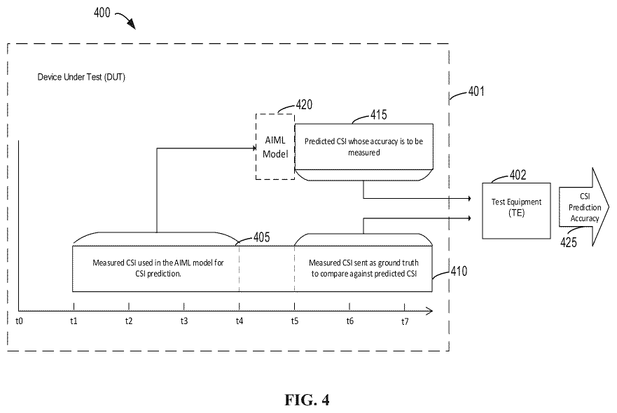

FIG. 4 illustrates an example of an interaction 400 between a Test Equipment (TE) 402 and Device Under Test (DUT) 401 in accordance with some example embodiments of the present disclosure. As illustrated in FIG. 4, the TE 402 may configure DUT 401 to measure the CSI using legacy approach as well as prediction of CSI for a specific time horizon, such as the measurements between time horizon t1-t7. The DUT 401 may use the measured CSI from t1-t4 to predict CSI between time horizon t5-t7. The DUT 401 may then report both the Measured CSI and Predicted CSI to the TE 402. It is noted that, in the context of this disclosure, the time horizon/time window may include a time window with length zero, i.e., a single time instance.

At block 405, the DUT 401 may start measuring the CSI from time interval t1. At block 410, when the DUT 401 reaches time interval t5, it may feed the measured CSI into a AI/ML Model 420 to generate the predicted CSI for the time horizon t5-t7. At block 410, the DUT 401 may continue to measure the CSI until time interval t7 as configured. In parallel, at block 415, the AI/ML Model 420 of the DUT 401 may predict the CSI for time horizon t5-t7.

At the end of time interval t7, the DUT 401 may both the measured CSI value, which is the ground truth, and predicted CSI value for time horizon t5-t7. Both these values are reported to the TE 402. The TE 402 may then compare the predicted CSI value (from block 415) against the ground truth (from block 410) to determine the accuracy of the CSI prediction 425.

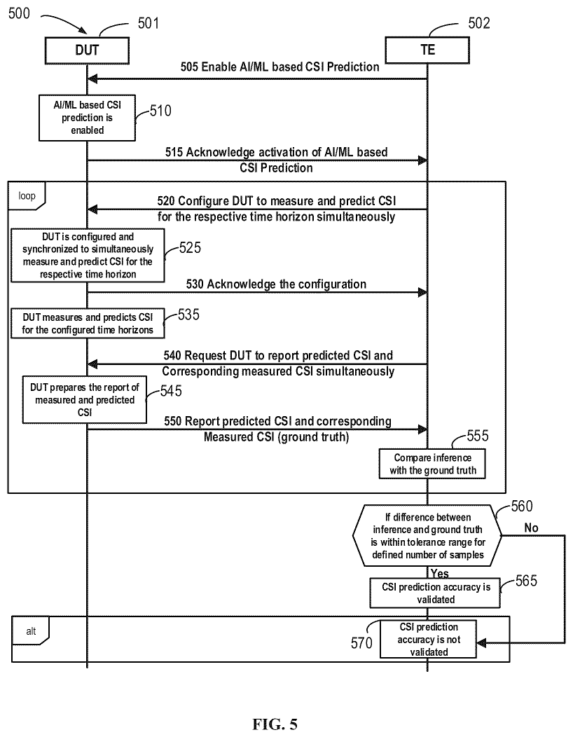

FIG. 5 illustrates an example of a flow of messages 500 between the DUT 501 and the TE 502 in accordance with some example embodiments of the present disclosure. As illustrated in FIG. 5, at step 505, the TE 502 may configure the DUT 501 to enable AI/ML based CSI prediction functionality. At step 510, the AI/ML based CSI prediction is enabled at DUT 501. At step 515, the DUT 501 may acknowledge the activation of AI/ML based CSI prediction to the TE 502.

At step 520, the TE 502 may configure the DUT 501 to simultaneously measure and predict the CSI for a given time horizon. At step 525, the DUT 501 may then configure itself to time synchronize and measure and predict the CSI for configured time intervals simultaneously. At step 530, the DUT 501 may acknowledge the configuration to the TE 502. At step 535, the DUT 501 may start to measure CSI and predict the CSI in parallel for the configured time horizon.

At step 540, the TE 502 may request a report on the predicted CSI as well as the measured CSI (ground truth) from the DUT 501. At step 545, the DUT may report the predicted CSI and measured CSI in the configured format. The configured format might be either a regular reporting time aligned with the reported predicted CSI reports, or alternatively the reporting of bulk data for a longer time period. The reporting of bulk data for a longer time period may enable a more efficient reporting of ground truth CSI as well as provide the DUT more time for the processing of the ground truth CSI reports. At step 550, the DUT 501 may report predicted CSI and corresponding measured CSI to the TE 502.

At steps 555-560, the TE 502 may compare the predicted CSI with the ground truth and derives the KPIs for the tolerance range. At step 565, if the KPIs are within the tolerance limit, then the accuracy is validated. Otherwise, at step 570, if the result is below tolerance level, then the test is considered as failed.

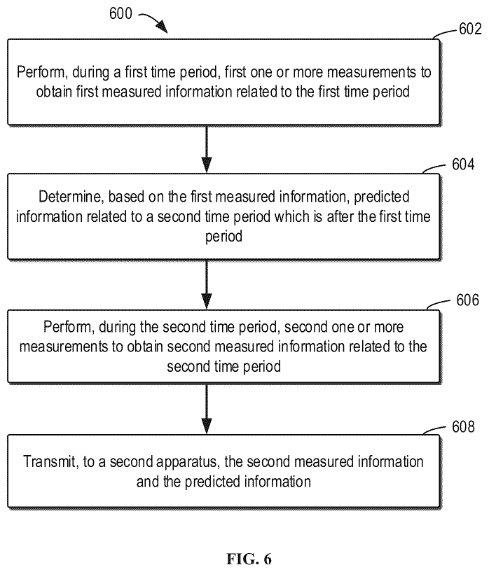

FIG. 6 illustrates a flowchart of a method 600 performed by an apparatus in accordance with some example embodiments of the present disclosure. For the purpose of discussion, the method 600 will be described from the perspective of the first apparatus 110 with reference to FIG. 1.

At 602, the first apparatus 110 may perform, during a first time period, first one or more measurements to obtain first measured information related to the first time period. At 604, the first apparatus 110 may determine, based on the first measured information and/or an artificial intelligence (AI)/machine learning (ML) model, predicted information related to a second time period which is after the first time period.

At 606, the first apparatus 110 may perform, during the second time period, second one or more measurements to obtain second measured information related to the second time period. At 608, the first apparatus 110 may transmit, to a second apparatus, the second measured information and the predicted information.

In some embodiments, prior to performing the first one or more measurements, the first apparatus 110 may receive, from the second apparatus, configuration information for configuring the first apparatus to obtain the second measured information and the predicted information related to the second time period. In some embodiments, the first apparatus may transmit, to the second apparatus, acknowledgement information indicating that the first apparatus has been configured to obtain the second measured information and the predicted information related to the second time period.

In some embodiments, the first apparatus may receive, from the second apparatus, a request that the first apparatus transmits the second measured information and the predicted information to the second apparatus, wherein the transmitting of the second measured information and the predicted information is responsive to the request. In some embodiments, the first apparatus may determine the predicted information during the second time period, inputting the first measured information into the AI/ML model.

In some embodiments, the first apparatus may perform the second one or more measurements by measuring first one or more channel state information (CSI)-reference signals (RS) from the second apparatus, wherein the first one or more CSI-RSs are transmitted during the second time period and at least one of (i) without noise and interference or (ii) with a power boost.

In some embodiments, the first one or more CSI-RSs are transmitted without noise and interference and are transmitted in parallel to second one or more CSI-RSs with noise and interference; and resources for receiving the first one or more CSI-RSs are orthogonal to resources for receiving the second one or more CSI-RSs. In some embodiments, the predicted information comprises at least one predicted CSI report, and the at least one predicted CSI report is transmitted to the second apparatus within one of the following a first reporting time period aligned with a plurality of predicted CSI reports; or a second reporting time period longer than the first reporting time period.

In some embodiments, the first measured information and the second measured information comprise measured CSI; and the predicted information comprises predicted CSI. In some embodiments, the first apparatus is a device under test (DUT), and the second apparatus is test equipment (TE).

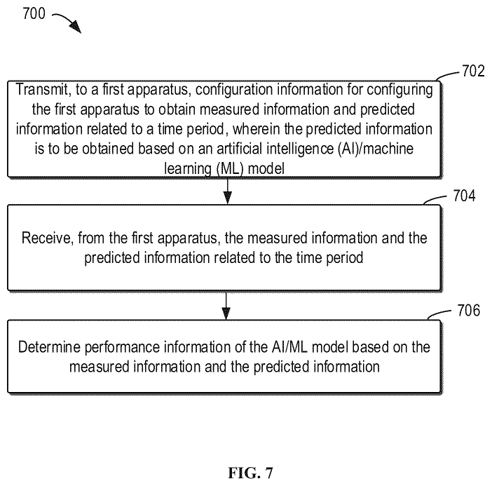

FIG. 7 illustrates a flowchart of a method 700 performed by an apparatus in accordance with some example embodiments of the present disclosure. For the purpose of discussion, the method 700 will be described from the perspective of the second apparatus 120 with reference to FIG. 1.

At 702, the second apparatus 120 may transmit, to a first apparatus, configuration information for configuring the first apparatus to obtain measured information and predicted information related to a time period, wherein the predicted information is to be obtained based on an artificial intelligence (AI)/machine learning (ML) model.

At 704, the second apparatus 120 may receive, from the first apparatus, the measured information and the predicted information related to the time period. At 706, the second apparatus 120 may determine performance information of the AI/ML model based on the measured information and the predicted information.

In some embodiments, the second apparatus 120 may receive, from the first apparatus, acknowledgement information indicating that the first apparatus has been configured to obtain the measured information and the predicted information related to the time period. In some embodiments, the second apparatus 120 may prior to receiving the measured information and the predicted information, transmit, to the first apparatus, a request that the first apparatus transmits the measured information and the predicted information to the second apparatus.

In some embodiments, the second apparatus 120 may determine the performance information by comparing the predicted information to the measured information; and deriving, based on the comparison, a key performance indicator (KPI) of the AI/ML model.

In some embodiments, the second apparatus 120 may determine a test on the AI/ML model is passed based on determining that the KPI is within a tolerance range; or determine the test on the AI/ML model is failed based on determining that the KPI is outside the tolerance range.

In some embodiments, the second apparatus may determine at least one requirement for testing the AI/ML model; and determine the configuration information based on the at least one requirement. In some embodiments, the second apparatus may transmit first one or more channel state information (CSI)-reference signals (RS) to the first apparatus, wherein the first one or more CSI-RSs are transmitted during the second time period and at least one of (i) without noise and interference or (ii) with a power boost.

In some embodiments, the first one or more CSI-RSs are transmitted without noise and interference and are transmitted in parallel to second one or more CSI-RSs with noise and interference; and resources for transmitting the first one or more CSI-RSs are orthogonal to resources for transmitting the second one or more CSI-RSs.

In some embodiments, the predicted information comprises at least one predicted CSI report, and the at least one predicted CSI report is received from the first apparatus within one of the following: a first reporting time period aligned with a plurality of predicted CSI reports; or a second reporting time period longer than the first reporting time period.

In some embodiments, the measured information comprises measured CSI; the predicted information comprises predicted CSI; and the performance information comprises CSI prediction accuracy. In some embodiments, the first apparatus is a device under test (DUT); and the second apparatus is test equipment (TE).

In some embodiments, an apparatus capable of performing the method 600 (for example, the first apparatus 110) may comprise means for performing the respective steps of the method 600. The means may be implemented in any suitable form. For example, the means may be implemented in a circuitry or software module.

In some embodiments, the apparatus comprises means for performing, during a first time period, first one or more measurements to obtain first measured information related to the first time period; means for determining, based on the first measured information and/or an artificial intelligence (AI)/machine learning (ML) model, predicted information related to a second time period which is after the first time period; means for performing, during the second time period, second one or more measurements to obtain second measured information related to the second time period; and means for transmitting, to a second apparatus, the second measured information and the predicted information.

In some embodiments, the apparatus comprises means for receiving, from the second apparatus, configuration information for configuring the first apparatus to obtain the second measured information and the predicted information related to the second time period prior to performing the first one or more measurements.

In some embodiments, the apparatus comprises means for transmitting, to the second apparatus, acknowledgement information indicating that the first apparatus has been configured to obtain the second measured information and the predicted information related to the second time period.

In some embodiments, the apparatus comprises means for receiving, from the second apparatus, a request that the first apparatus transmits the second measured information and the predicted information to the second apparatus, wherein the transmitting of the second measured information and the predicted information is responsive to the request. In some embodiments, the apparatus comprises means for determining the predicted information during the second time period, by inputting the first measured information into the AI/ML model.

In some embodiments, the apparatus comprises means for performing the second one or more measurements by measuring first one or more channel state information (CSI)-reference signals (RS) from the second apparatus, wherein the first one or more CSI-RSs are transmitted during the second time period and at least one of (i) without noise and interference or (ii) with a power boost.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, an apparatus capable of performing the method 700 (for example, the second apparatus 120) may comprise means for performing the respective steps of the method 700. The means may be implemented in any suitable form. For example, the means may be implemented in a circuitry or software module.

In some embodiments, the apparatus comprises means for transmitting, to a first apparatus, configuration information for configuring the first apparatus to obtain measured information and predicted information related to a time period, wherein the predicted information is to be obtained based on an artificial intelligence (AI)/machine learning (ML) model; means for receiving, from the first apparatus, the measured information and the predicted information related to the time period; and means for determining performance information of the AI/ML model based on the measured information and the predicted information.

In some embodiments, the apparatus comprises means for determining the performance information by comparing the predicted information to the measured information; and means for deriving, based on the comparison, a key performance indicator (KPI) of the AI/ML model.

In some embodiments, the apparatus comprises means for determining a test on the AI/ML model is passed based on determining that the KPI is within a tolerance range; or means for determining the test on the AI/ML model is failed based on determining that the KPI is outside the tolerance range.

In some embodiments, the apparatus comprises means for determining at least one requirement for testing the AI/ML model; and means for determining the configuration information based on the at least one requirement. In some embodiments, the apparatus comprises means for transmitting first one or more channel state information (CSI)-reference signals (RS) to the first apparatus, wherein the first one or more CSI-RSs are transmitted during the second time period and at least one of (i) without noise and interference or (ii) with a power boost.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

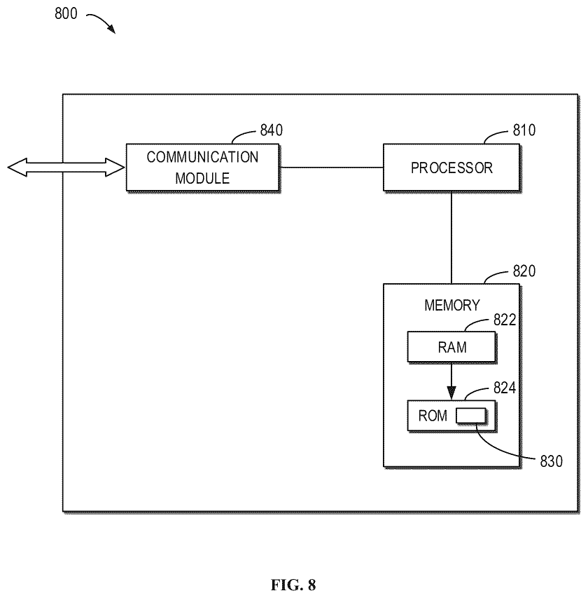

FIG. 8 illustrates a simplified block diagram of a device 800 that is suitable for implementing some example embodiments of the present disclosure. The device 800 may be provided to implement a communication device, for example, the first apparatus 110 and the second apparatus 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2 to 7. The embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like.

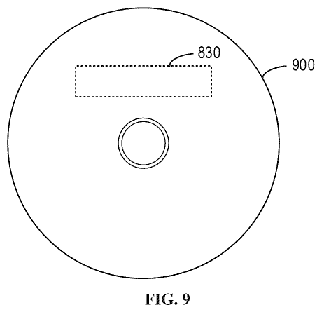

FIG. 9 illustrates a block diagram of an example of a computer readable medium 900 in accordance with some example embodiments of the present disclosure. The computer readable medium 900 has the program 930 stored thereon. It is noted that although the computer readable medium 900 is depicted in form of CD or DVD in FIG. 9, the computer readable medium 900 may be in any other form suitable for carry or hold the program 930.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIG. 5 or 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
perform, during a first time period, first one or more measurements to obtain first measured information related to the first time period;
determine, based on the first measured information, predicted information related to a second time period which is after the first time period;
perform, during the second time period, second one or more measurements to obtain second measured information related to the second time period; and
transmit, to a second apparatus, the second measured information and the predicted information.

2. The first apparatus of claim 1, wherein the first apparatus is further caused to:
prior to performing the first one or more measurements, receive, from the second apparatus, configuration information for configuring the first apparatus to obtain the second measured information and the predicted information related to the second time period.

3. The first apparatus of claim 2, wherein the first apparatus is further caused to:
transmit, to the second apparatus, acknowledgement information indicating that the first apparatus has been configured to obtain the second measured information and the predicted information related to the second time period.

4. The first apparatus of claim 1, wherein the first apparatus is further caused to:
receive, from the second apparatus, a request that the first apparatus transmits the second measured information and the predicted information to the second apparatus, wherein the transmitting of the second measured information and the predicted information is responsive to the request.

5. The first apparatus of claim 1, wherein the first apparatus is caused to determine the predicted information by:
during the second time period, inputting the first measured information into an artificial intelligence (AI)/machine learning (ML) model.

6. The first apparatus of claim 1, wherein the first apparatus is caused to perform the second one or more measurements by:
measuring first one or more channel state information (CSI)-reference signals (RS) from the second apparatus, wherein the first one or more CSI-RSs are transmitted during the second time period and at least one of (i) without noise and interference or (ii) with a power boost.

7. The first apparatus of claim 6, wherein:
the first one or more CSI-RSs are transmitted without noise and interference and are transmitted in parallel to second one or more CSI-RSs with noise and interference; and
resources for receiving the first one or more CSI-RSs are orthogonal to resources for receiving the second one or more CSI-RSs.

8. The first apparatus of claim 1, wherein the predicted information comprises at least one predicted CSI report, and the at least one predicted CSI report is transmitted to the second apparatus within one of the following:
a first reporting time period aligned with a plurality of predicted CSI reports; or
a second reporting time period longer than the first reporting time period.

9. The first apparatus of claim 1, wherein:
the first measured information and the second measured information comprise measured CSI; and
the predicted information comprises predicted CSI.

10. The first apparatus of claim 1, wherein:
the first apparatus is a device under test (DUT); and
the second apparatus is test equipment (TE).

11. The first apparatus of claim 1, wherein the first apparatus is further caused to:
determine, based on the first measured information and the AI/ML model, the predicted information related to the second time period.

12. A second apparatus comprising:
at least one processor; and
at least one memory storing instructions that, when executed by the at least one processor, cause the second apparatus at least to:
transmit, to a first apparatus, configuration information for configuring the first apparatus to obtain measured information and predicted information related to a time period, wherein the predicted information is to be obtained based on an artificial intelligence (AI)/machine learning (ML) model;
receive, from the first apparatus, the measured information and the predicted information related to the time period; and
determine performance information of the AI/ML model based on the measured information and the predicted information.

13. The second apparatus of claim 12, wherein the second apparatus is further caused to:
receive, from the first apparatus, acknowledgement information indicating that the first apparatus has been configured to obtain the measured information and the predicted information related to the time period.

14. The second apparatus of claim 12, wherein the second apparatus is further caused to:
prior to receiving the measured information and the predicted information, transmit, to the first apparatus, a request that the first apparatus transmits the measured information and the predicted information to the second apparatus.

15. The second apparatus of claim 12, wherein the second apparatus is caused to determine the performance information by:
comparing the predicted information to the measured information; and
deriving, based on the comparison, a key performance indicator (KPI) of the AI/ML model.

16. The second apparatus of claim 15, wherein the second apparatus is further caused to:
based on determining that the KPI is within a tolerance range, determine a test on the AI/ML model is passed; or
based on determining that the KPI is outside the tolerance range, determine the test on the AI/ML model is failed.

17. The second apparatus of claim 12, wherein the second apparatus is further caused to:
determine at least one requirement for testing the AI/ML model; and
determine the configuration information based on the at least one requirement.

18. The second apparatus of claim 12, wherein the second apparatus is further caused to:
transmit first one or more channel state information (CSI)-reference signals (RS) to the first apparatus, wherein the first one or more CSI-RSs are transmitted during the second time period and at least one of (i) without noise and interference or (ii) with a power boost.

19. The second apparatus of claim 18, wherein:
the first one or more CSI-RSs are transmitted without noise and interference and are transmitted in parallel to second one or more CSI-RSs with noise and interference; and
resources for transmitting the first one or more CSI-RSs are orthogonal to resources for transmitting the second one or more CSI-RSs.

20. The second apparatus of claim 12, wherein the predicted information comprises at least one predicted CSI report, and the at least one predicted CSI report is received from the first apparatus within one of the following:
a first reporting time period aligned with a plurality of predicted CSI reports; or
a second reporting time period longer than the first reporting time period.

21. The second apparatus of claim 12, wherein:
the measured information comprises measured CSI;
the predicted information comprises predicted CSI; and
the performance information comprises CSI prediction accuracy.

22. The second apparatus of claim 12, wherein:
the first apparatus is a device under test (DUT); and
the second apparatus is test equipment (TE).

23. A method comprising:
performing, at a first apparatus during a first time period, first one or more measurements to obtain first measured information related to the first time period;
determining, based on the first measured information, predicted information related to a second time period which is after the first time period;
performing, during the second time period, second one or more measurements to obtain second measured information related to the second time period; and
transmitting, to a second apparatus, the second measured information and the predicted information.

24. A method comprising:
transmitting, at a second apparatus and to a first apparatus, configuration information for configuring the first apparatus to obtain measured information and predicted information related to a time period, wherein the predicted information is to be obtained based on an artificial intelligence (AI)/machine learning (ML) model;
receiving, from the first apparatus, the measured information and the predicted information related to the time period; and
determining performance information of the AI/ML model based on the measured information and the predicted information.
